(19) United States
(12) Patent Application Publication
(10) Pub. No.: US 2008/0231795 A1
(43) Pub. Date: Sep. 25, 2008

(54) ANTI-BALLISTIC LENS STRUCTURE AND METHOD OF MAKING THE SAME

(75) Inventor: Jon P. Cartier, Guilford, CT (US)

Correspondence Address: PERMAN & GREEN, 425 POST ROAD, FAIRFIELD, CT, 06824, US

(73) Assignee: Beloptix, Inc., Old Lyme, CT (US)

(21) Appl. No.: 11/690,597

(22) Filed: Mar. 23, 2007

(51) Int. Cl. B05D 5/06; C08J 7/04; B32B 7/00; G02C 7/10; F41H 1/04; G02C 7/12

(52) U.S. Cl. 351/49; 2/15; 2/424; 244/129.3; 351/163; 351/44; 427/372.2; 427/498; 427/560; 428/410; 52/171.3; 2/6.7; 296/200; 428/98; 52/204.5

(57) ABSTRACT

A method of making a lens structure is provided comprising a first step of providing an eyewear lens substrate blank having a polarized layer or a helmet shield substrate blank. A step of spin coating a surface of the lens substrate blank with a photochromic material is then provided. Steps of curing the lens substrate blank by heating and coating the surface of the lens substrate blank having the photochromic material with a hard coating is then provided.

### RELATED APPLICATIONS

This application is related to U.S. patent application Ser. No. 10/909,781 filed on Aug. 2, 2004 which is hereby incorporated by reference herein in its entirety.

### BACKGROUND

1. Field of the Exemplary Embodiment

The exemplary embodiment relates to an anti-ballistic lens structure and method of making the same, and more particularly, to an anti-ballistic lens structure and method of making a lens structure having a photochromic material.

2. Description of Earlier Related Developments

Eyewear and eye protection devices extend to uses such as prescription eye wear, sports wear, fashion wear, visors and helmets for uses such as for consumer eye protection, racing or aircraft use, or for industrial protection. In high performance eyewear, features such as a high degree of impact resistance or anti-ballistic protection are desirable, for example, for military, police, security and sporting applications or otherwise. Here, it is desirable to use materials that are suitably tough, yet easily formed into prescription lenses or suitable shapes. A problem arises when the combined features of both anti-ballistic and photochromic behavior are desired with such a lens or other transparent material. A further problem arises when fabricating coated lenses where a high coating quality is desired with minimum removal of unwanted material. Accordingly, there is a desire to provide anti-ballistic performance with features, such as polarization and photochromic coating with a method of manufacturing the same with a high quality film without flaws.

### SUMMARY OF THE EMBODIMENTS

In accordance with one exemplary method, a method of making an anti-ballistic lens structure is provided comprising providing a lens substrate blank of anti-ballistic material, and applying a photochromic material to a surface of the lens substrate blank.

In accordance with another exemplary method, a method of making an anti-ballistic lens structure is provided comprising providing a lens substrate blank of anti-ballistic material, applying a photochromic material to a surface of the lens substrate blank, and curing the lens substrate blank.

In accordance with one exemplary embodiment, an anti-ballistic eyewear lens structure is provided having a lens substrate of anti-ballistic material, and a functional layer coated on the lens substrate, the functional layer comprising a photochromic material. No hard coat is required.

In accordance with another exemplary embodiment, an anti-ballistic eyewear lens structure is provided having a lens substrate of anti-ballistic material having a polarizing layer, and a functional layer coated on the lens substrate, the functional layer comprising a photochromic material. The functional layer being coated on to the lens substrate by spin coating a surface of the lens substrate with a liquid resin of the photochromic material and curing the lens substrate blank by heating.

In accordance with another exemplary embodiment, an anti-ballistic eyewear lens structure is provided having a lens substrate of anti-ballistic material, and a functional layer coated on the lens substrate, the functional layer comprising a photochromic material. The functional layer is coated on to the lens substrate by spin coating a surface of the lens substrate with a liquid resin of the photochromic material and curing the lens substrate blank by heating.

In accordance with another exemplary embodiment an anti-ballistic eyewear lens structure is provided having an anti-ballistic lens substrate having another layer, and a functional layer applied to the other layer of the lens substrate, the functional layer comprising a photochromic material.

In accordance with another exemplary embodiment, anti-ballistic eyewear is provided having a frame and at least one anti-ballistic lens, the anti-ballistic lens being shaped to a non-prescription specification and having a lens structure having an anti-ballistic lens substrate having another layer, and a functional layer applied to the other layer of the lens substrate, the functional layer comprising a photochromic material. The other layer of the lens substrate comprises a hard coat material.

In accordance with another exemplary embodiment anti-ballistic eyewear is provided having a prescription insert frame having clear prescription lenses, the clear prescription lenses having an index of refraction of 1.50, 1.56, 1.60, 1.67, 1.71, or 1.74, a frame and at least one non-prescription anti-ballistic lens in front of the prescription lenses, the non-prescription anti-ballistic lens having a lens structure comprising a anti-ballistic lens substrate having another layer, and a functional layer applied to the other layer of the lens substrate, the functional layer comprising a photochromic material. The other layer of the lens substrate comprises a hard coat.

In accordance with another exemplary embodiment, an anti-ballistic protective helmet having head protection gear and a visor or shield is provided having a anti-ballistic lens substrate having another layer, and a functional layer applied to the other layer of the lens substrate, the functional layer comprising a photochromic material. The other layer of the lens substrate comprises a hard coat.

In accordance with another exemplary embodiment, anti-ballistic eyewear is provided having a frame and at least one anti-ballistic lens, the anti-ballistic lens being shaped to a prescription or non-prescription specification and having an anti-ballistic lens structure comprising a anti-ballistic lens substrate having another layer, and a functional layer applied to the other layer of the anti-ballistic lens substrate, the functional layer comprising a photochromic material.

In accordance with another exemplary embodiment, an anti-ballistic protective helmet having head protection gear and a visor or shield is provided having a anti-ballistic transparent or translucent substrate, and a functional layer applied to the anti-ballistic transparent or translucent substrate, the functional layer comprising a photochromic material.

In accordance with another exemplary embodiment, an anti-ballistic aircraft cockpit window is provided having a anti-ballistic transparent substrate, and a functional layer applied to the anti-ballistic lens substrate, the functional layer comprising a photochromic material.

In accordance with another exemplary embodiment, an anti-ballistic residential or office building window is provided an anti-ballistic transparent substrate, and a functional layer applied to the anti-ballistic transparent substrate, the functional layer comprising a photochromic material. polycarbonate or polyurethane.

In accordance with another exemplary embodiment, an anti-ballistic vehicular window is provided having an anti-ballistic transparent substrate, and a functional layer applied to the other layer of the anti-ballistic transparent substrate, the functional layer comprising a photochromic material.

### BRIEF DESCRIPTION OF THE DRAWINGS

The foregoing aspects and other features of the exemplary embodiments are explained in the following description, taken in connection with the accompanying drawings, wherein:

FIG. 1 is an isometric view of eyewear incorporating features in accordance with an exemplary embodiment;

FIG. 2 is an isometric view of a helmet and visor shield incorporating features in accordance with another exemplary embodiment;

FIG. 3 is a schematic cross section of a lens in accordance with still another exemplary embodiment;

FIG. 4 is a schematic view of an apparatus for making a lens structure in accordance with an exemplary embodiment;

FIG. 5 is a flow diagram of a method of making a lens structure in accordance with an exemplary embodiment;

FIG. 6 is a schematic elevation view of a vehicle incorporating features of the exemplary embodiment in accordance with yet still another exemplary embodiment;

FIG. 7 is a schematic elevation view of a building incorporating features of the exemplary embodiment in accordance with still another exemplary embodiment; and

FIG. 8 is a schematic perspective view of a fixture and workpiece incorporating features in accordance with another exemplary embodiment.

### DETAILED DESCRIPTION OF THE EXEMPLARY EMBODIMENT(S)

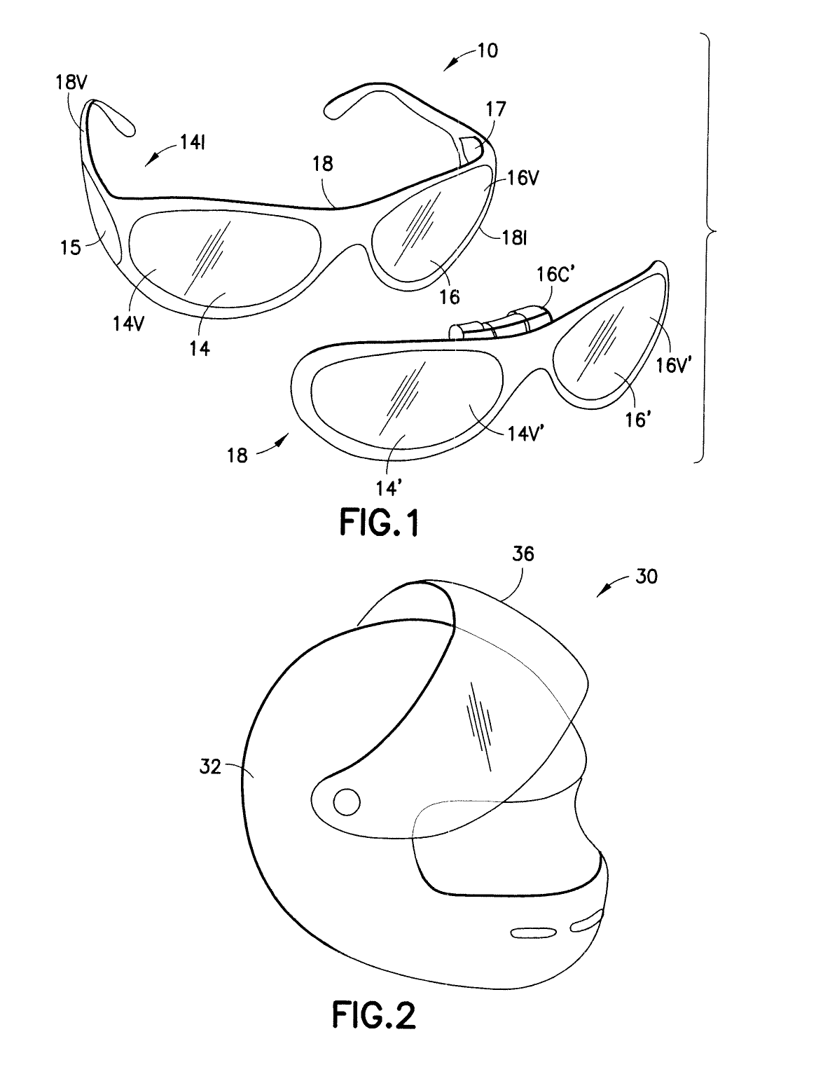

Referring to FIG. 1, there is shown, an isometric view of anti-ballistic eyewear 10 incorporating features in accordance with an exemplary embodiment. Referring also to FIG. 2, there is shown an isometric view of an anti-ballistic helmet and visor shield 30 incorporating features in accordance with another exemplary embodiment. Although the exemplary embodiment will be described with reference to the embodiments shown in the drawings, it should be understood that the exemplary embodiment can be embodied in many alternate forms of embodiments. In addition, any suitable size, shape or type of elements or materials could be used.

Referring again to FIG. 1 the anti-ballistic eyewear 10, incorporating features in accordance with an exemplary embodiment, illustrated therein are representative eyeware. Anti-ballistic eyewear 10 may have features such as disclosed in U.S. patent application Ser. No. 10/909,781 filed on Aug. 2, 2004 which is hereby incorporated by reference herein in its entirety. As noted, anti-ballistic eyewear 10 are generally illustrated as spectacles in FIG. 1, and may include different characteristics so that the eyewear may be used, for example, for fashion, sports, active wear or otherwise for sun wear. In alternate embodiments, the eyeware may have any other desired form such as goggles. In the exemplary embodiment, anti-ballistic eyewear 10 may generally incorporate for example lenses 14, 16, side lenses 15, 17 and frame assembly 18. Lenses 14, 16 or side lenses 15, 17 may be anti-ballistic lenses as will be described further below. Frame assembly 18 may be also be arranged such that eyewear 10, frame and lenses in combination and/or alone satisfy the anti-ballistic criteria as per Mil-Std-662 for armor. Anti-ballistic eyewear 10 may for example incorporate anti-ballistic lenses formed to meet performance criteria for military combat eyewear protection system (MCEPS). The anti-ballistic eyewear and lenses, frame and transparency combination, designed to meet testing criteria of Mil-Std-662 may also satisfy testing criteria according to ANSI-Z87.1, both of which are incorporated by reference herein in their entirety. In the exemplary embodiment eyewear 10, tested pursuant to MIL-Std-662, met the criteria of two levels of anti-ballistic transparent armor: level I, transparent armor capable of withstanding .15 cal. projectile and level II, capable of withstanding .22 cal. impact. In alternate embodiments, the eyeware (e.g. spectacles, goggles) may be configured to withstand testing criteria of ANS1-Z87.1, which specifies testing for high velocity impact. In the instant application, anti-ballistic eyewear 10, the frame and transparency combination are designed to meet testing requirements for both standards. As an example of testing conducted, ballistics testing, as specified in MIL-PRF-31013, clause 3.5.1.1. were conducted on spectacle samples, similar to eyeware 10 as follows. A test pistol with projectile having .15 caliber, 5.8 grain, T37 shaped projectile and Nitrogen Propellant were used with a Horizontal Impact Test Bench with Oehler Research Precision Ballistic Chronograph and a Ballistics Test Headform with 0.002 inch thick aluminum foil witness sheet. Testing protocols in accord with good laboratory practice were employed for all tests and all tests were conducted in a standard laboratory atmosphere. Ten samples were selected at random from the quantity provided. Samples were mounted on the ballistics test headform in an as worn position. Integral to the test headform, a witness sheet composed of 0.002 aluminum foil within 2 inches impact area. Samples were impacted with a .15 caliber projectile a velocity of 640 to 660 ft/s. One impact per sample, normal to the front curve, coincident with either the right or left eye. Any velocity loss of the projectile is considered to be negligible with respect to the geometries of the test bench. The result was considered to be a success if the aluminum foil witness sheet was not punctured or if the lens did not crack. The samples as assessed met the VO impact requirements for spectacles, the anti-ballistic armor lenses (similar to lenses 14, 14′) did not crack and witness sheet was not punctured. The eyeware was also successfully tested with .22 caliber projectile with a velocity of about 6 to 660 ft/s, achieving similar satisfactory results.

In the case of fashion eyewear, the frame or lenses may have an exterior shape, indicia, or arrangement 14I, 18I related to a popular or otherwise fashionable characteristic. In the case of sports or active wear, the eyewear may include other predetermined characteristics related to sport activity of the wearer as will be described below. In an alternate embodiment, frame 18 may be a prescription insert frame having, for example, clear prescription lenses. The clear prescription lenses may having an index of refraction of 1.50, 1.56, 1.60, 1.67, 1.71, or 1.74. In alternate embodiments, other index of refraction could be provided. As noted before, frame 18′ and lenses 14′, 16′ may have anti-ballistic properties and be provided in front of or behind the prescription lenses, and may be removable or movable or alternately fixed to the eyewear 10. For example, in the prescription or otherwise non-plano eyeware, the prescription lenses may be snapped into the back of the eyewear lens. In still other alternate embodiments, the lenses 14, 16 in the frame 18 may be non-prescription or piano lenses, and the frame 18 is capable of holding one or more additional or supplemental prescription inserts 16′. In the embodiment shown in FIG. 1, only one prescription insert 16′ is shown for example purposes, also frame 18 may be capable of receiving any desired number of prescription or non-plano inserts. The prescription inserts 16″ are generally similar to lenses 14, 16 as will be described in greater detail below, but in the case where lenses 14, 16 are non-prescription, prescription inserts 16′ are shaped in accordance with a prescription specification. The prescription inserts 16′ may be shaped to be admitted into the eye loops of the frame 18, or in alternate embodiments may have any suitable shape. A connector or mount 16C′ may be used to attach or mount the inserts 16′ to the frame 18. The connector 16C′ may be of any suitable type, such as spiral grooves, tabs, clips or detents, for mounting and stably holding the inserts 16′ on the frame 18, and may be integrally formed on the frame 18 (as shown in FIG. 1), or on the inserts 16′ or both. In alternate embodiments, fasteners such as screws, may be used to attach the prescription inserts 16′ to the frame 18. Although in the embodiment shown in FIG. 1, the prescription inserts 16′ are depicted as being located (when mounted on frame 18) behind non-prescription lenses 14, 16 in alternate embodiments, the prescription inserts may be mounted in front of the lenses. In still other alternate embodiments, the non-prescription lenses 14, 16 may be interchangeable or swapped with the prescription inserts 16′ such as by “snapping out” (removing) the non-prescription lenses and “snapping in” (mounting) the prescription inserts 16′ on the frame.

Three primary factors affect good vision outdoors: light, glare, and the ability of the eye to process light optimally. Lens characteristics 14V, 14V′, 16V, 16V′ may be provided in the lenses 14, 14′, 16, 16′ of eyewear or sportswear 10 to optimize these factors for vision in conditions, for example, outdoor sports, hunting and fishing use. With optimum polarization, the amount of glare is optimized for a given optical condition. With photochromics the amount of light entering the eye is controlled. With color, certain wavelengths of light are filtered. Vision is optimized with optimal combinations of glare, light intensity, and color for conditions, for example, in the fields and streams, in the mountains and brush, under tree cover or on the open water regardless of the sunlight condition. Optimization involves balancing glare reduction, light transmission and optical clarity in a single lens that can adapt to any light condition, indoors or out. In the exemplary embodiment the vision optimization is combined with anti-ballistic eyeware as will be described in greater detail.

The first factor that affects good vision is light. Light may originate from sources, such as the sun, allowing sight of objects by the reflection of the light off of the object and into the eye. Inadequate light, for example, early morning presents difficulty to distinguish objects, particularly at long distances. As light intensity increases, for example, where the sun rises and increases its illumination, objects are much more visible. With high intensities, for example, with high noon, the human eye may sense too much light or sun and the pupil opening contracts to limit the amount of sun. Not all wavelengths of light are healthy for the human eye. Ultraviolet and blue light deteriorate the retina and other parts of the eye system. With ozone layer depletion from pollution, more of this harmful light may enter the eye unless protection is provided, for example, in the form of sunglasses 10. Lenses 14, 16 may be tinted to reduce the amount of light that enters the eye. Lenses 14, 16 may be treated to block ultraviolet light that would otherwise go through the lens and into the eye. Two aspects of tinting may affect vision: the degree of tint and the color. For many outdoor applications if the sunglass is too dark, the lenses may block out so much light that the targets image is difficult to discriminate and identify. Certain colors allow specific wavelengths of light into the eye, and selectively block out others. Brown and orange, for example, may block out blue light, and allow for very good contrast. Gray or blue tints may block out all wavelengths, resulting in a flattening of the image. When wearing such sunglasses in low light conditions, the human eye must work harder to try to let in more light, resulting in eyestrain and fatigue.

The second factor that affects good vision is glare. Visual acuity may be adversely affected by glare, which is the visual noise that results from sunlight reflecting off of various surfaces, for example, snow, water, dashboards, leaves, windows, fog, and even raindrops. The human eye may be irritated by such reflected or scattered light, and humans react to this glare by squinting, an instinctive action that reduces the effectiveness of the eye system. Polarized lenses 14, 16 have been developed to block out this glare or visual noise. Most polarized lens manufacturers have assumed that the more polarization the better; thus, most polarized lenses today have a polarized efficiency of 99.9%—where only 0.1% of the glare or visual noise is allowed to enter the eye. Such extreme polarization may actually limit visual acuity because the human eye was “designed” by evolution to process a certain amount of glare for good depth perception. Therefore, too much polarization can also have a flattening affect on the image; for example, with over polarized lenses, it may be difficult to discriminate a target object because it does not have as much dimension or depth, as a further example, snow skiing accidents have revealed that the polarized lenses being worn may limit the ability to discern tracks in the snow and changes in trail surfaces.

The third factor that affects good vision is the eye's ability to process light optimally. The function of the human eye is to process light reflected off of surfaces by channeling the light through a lens system such that a focused image is placed on the retina. The image is then processed into the brain for recognition and behavioral reaction. Approximately 60% of the human population has difficulty focusing these images properly, and must wear some form of vision correction. As human's age, their ability to focus deteriorates, initially for near vision (i.e. presbyopia) but then often for distance as well. For example, it has been estimated that for the outdoor sports of hunting and fishing, about 70% of all participants need some form of visual correction. It may be considered that visual acuity for such outdoor activities closely compares to what may exist in military or police outdoor activities with similar visual tasking. The ability to process light optimally is a function of managing the amount and wavelengths of light and glare that enters the eye. If the amount of light and glare is too extreme, the muscles of the eye will contract (by squinting), and the lens system works less effectively. Conversely, if the amount of light that goes into the eye is inadequate for good image transmission, or not enough glare is allowed into the eye for good depth discrimination, the ability to discriminate and identify the image is limited. Where prescription glasses or contact lenses are used, the importance of effective process management of light may be more important because such eyes are usually less able to adjust or compensate for light and glare levels. By being either convex or concave, corrective lenses optically change the way light is bent by the eye's lens system so that the image that is placed on the retina is in focus. In addition to being the precise curvature to provide this focus, the lenses should also be optimally tinted and polarized to ensure optimum vision outdoors.

Polarization may be employed to manage glare. Some glare is desired for proper depth perception whereas a high level of elimination, for example, elimination of 99.9% of glare results in an extreme flattening of the image. 100% polarization efficiency means that 0% of the glare is present; 99% polarization efficiency means that 1% of the glare is present. Higher polarization efficiency, such as for example, 99% polarization efficiency flattens the image, and makes the lens much darker than a lower polarization efficiency lens, such as for example, 90%. Optimum polarization efficiency may be achieved by reducing the polarization efficiency for a given condition. Reduced polarization efficiency, such as for example, a 90% or less polarization efficiency may provide a clearer, more defined, contrasted, and better three-dimensional image. Polarization efficiencies may be combined with tinting to optimize clarity, definition and contrasted images. Examples of optimized tinting and polarization efficiency combinations include, for example, Amber, Brown and Purple in combination with a 90% polarization efficiency; Target Orange in combination with a 55% polarization efficiency and Yellow in combination with a about 14 to 25% polarization efficiency. As a result, these combinations may be optimized for applications, such as military. For example, objects or persons can be discerned more clearly at greater distances, and, in the case of underwater objects, at greater depths. Better vision may be achieved with optimum polarization, for example, 90% for amber and brown lenses in combination with a photochromic self-adjusting tint.

Photochromic coating process may be employed to affect tint and darkness, and may be combined with optimum polarization. For example, photochromic coating may screen out only 50 percent of the light as opposed to 85 percent or as desired. Photochromic coating makes the lens variable in tint, for example, the brighter the sun, the darker the lens becomes. As the sun goes up and down or in and out of the clouds, the lens darkens automatically allowing the optimum amount of light to enter the eye. Where the optimum degree of polarization is employed, for example if the lenses are too polarized, they are too dark; and the image seen is flattened. By combining photochromics with polarization, example 10 (e.g. spectacles, goggles, etc.) may give the best possible vision, for example, in the outdoors. Traditionally, polarized lenses have been too dark for many daylight conditions, such as early morning/late afternoon, and undercover. With photochromic coating, lenses darken and lighten based on the sunlight intensity and will block out the glare with optimum polarization efficiency where polarization efficiency is employed. The result is better vision, for example in fields and streams, in the mountains and brush, under tree cover or the open water—regardless of the sunlight condition. Photochromic coatings enable a lens to automatically adjust in tint level based on the intensity of light, such as sunlight. In low light conditions, such as in early morning and late in the day when the sun is not as bright, the lenses have a medium tint. As light intensity increases, such as where sunlight becomes brighter, the lenses automatically darken, and then subsequently lighten as the sun starts to go down in the horizon. Photochromic coating may be combined with a polarized lens, where the polarization efficiency is optimized, for example, to the optimum percentage of 90%. In comparison with a 99.9% polarization efficiency combination, the 9.99% difference results in much better optical discrimination, for example with shooting or observation targets because the human eye uses some glare to effectively determine distance and depth perception. Lens darkness may also be referred to as color density. A photochromic coating applied to the front surface of the lens enables the lens to darken and lighten based on the amount of U.V. light present, sometimes, for example, as much as 50%. If a lens is too dark, the wearer cannot see the image well enough to identify and discriminate. With photochromic coating, the lens tint level is optimized for the light or sunlight condition present. Most conventional premium sunglasses are too dark because of the polarization efficiency, and because the gray or blue colors are generally used. Some of the conventional premium sunglass companies are now offering their products in lighter colors. Moreover, none of these characteristics are available in conventional anti-ballistic eyeware. The exemplary embodiments overcome this deficiency as will be described in greater detail below.

Lens characteristics 14V, 16V may be for example that lens 14, 16 may have color, such as amber, brown, purple orange, aquamarine, blue, gray and yellow or otherwise that may be selected depending upon the application or conditions of use. For example, target-orange color, when fully activated outdoors, the lenses turn a dark brown whereas, when indoors, the lenses return to orange in three to four minutes. Alternately, colors may be light amber, which changes to dark amber, purple, which changes to deep purple, and yellow, which becomes gray-yellow. Yellow enhances contrast in dim, hazy light of morning and afternoon, enhancing vision, for example to spot game. Purple, in addition to being a highly effective color for general purposes, also enhances sharpness, enhancing vision, for example for shooting pigeons in the bright sun. Lens colors may be employed for different activities, for example specific outdoor activities, thereby selectively allowing certain wavelengths of light into the eye for optimum vision. Photochromic or variable tint lenses may be provided with different colors, for example, as follows. For fresh water operations, amber. For general lake and salt-water use, brown. For big game hunting and wild turkey, purple. For hunting for waterfowl, trap, skeet and Orange. For low light level, such as before dawn, yellow.

Frame 18 may be plastic, metal or composite, with structure 18S suited to withstand ballistics as, pursuant to MIL-STD-662 (as described before) or high impact loads per ANSI-Z87.1, and may be provided in some indicia, colors or patterns 18I, for example, black, tortoise or RealTree® camo. Side panels 15, 17 may be colored the same as lenses 14, 16 or otherwise and allow for peripheral vision and added protection. In the exemplary embodiment, the frame 18 has features for maximum prescription range such as a polarized progressive (no-line bifocal or multifocal) lens, and has side panels 15, 17 to block the sunlight coming in from the sides. Maximum prescription range is provided by designing the frame front in such a way that a wide range of base curves of lenses can be installed in the frame. A typical wrap-style sports frame has a very steep curvature (base curve 8 or higher), that prevents near-sighted correction of −3.00 or more without optical distortion. Because of its design, frame 18 can accommodate from a +3.00 to a −7.00 with no optical distortion. Lens 14, 16 may be provided with or without a prescription curvature, for example, a prescription Rx Range:Single Vision (+3.00 to −7.00 with up to 4.00 Cyl) or Progressive (Distance: +2.50 to −4.00 with up to 3.00 Cyl/Add: +1.00 to +3.00). Eyewear for military or police applications may have lightweight lenses, such as lightweight plastic lenses, with a high enough refractive index to correct for prescriptions without being thick at the edges, and that are anti-ballistic. Further, it is desired that the lenses be photochromic to darken to protect the eyes in bright sunlight and lighten in the shade, on overcast days and when worn indoors in order to use one pair of glasses for all conditions. Additionally, it is desired that the lenses be polarized to provide protection from what is most stressful to the eyes reflective glare and ultraviolet rays.

Referring now to FIG. 2, there is shown an isometric view of an anti-ballistic helmet with anti-ballistic or transparent armor visor or shield 30 incorporating features in accordance with another exemplary embodiment. Helmet and visor or shield 30 has helmet or head protection gear 32 and a polycarbonate visor or shields that may incorporate features of anti-ballistic lenses 14, 16 above. Currently protective helmets must have two shield: one that is clear for driving in low light conditions, and one that is tinted and/or polarized for driving in bright conditions. An anti-ballistic shield with a photochromic coating eliminates the need for two visors or shields. This photochromic visor or shield will darken to protect the eyes in bright sunlight, and lighten in the low light conditions in order to use one visor or shield for all conditions and for changing conditions. In alternate embodiments, more visors or shields may be provided.

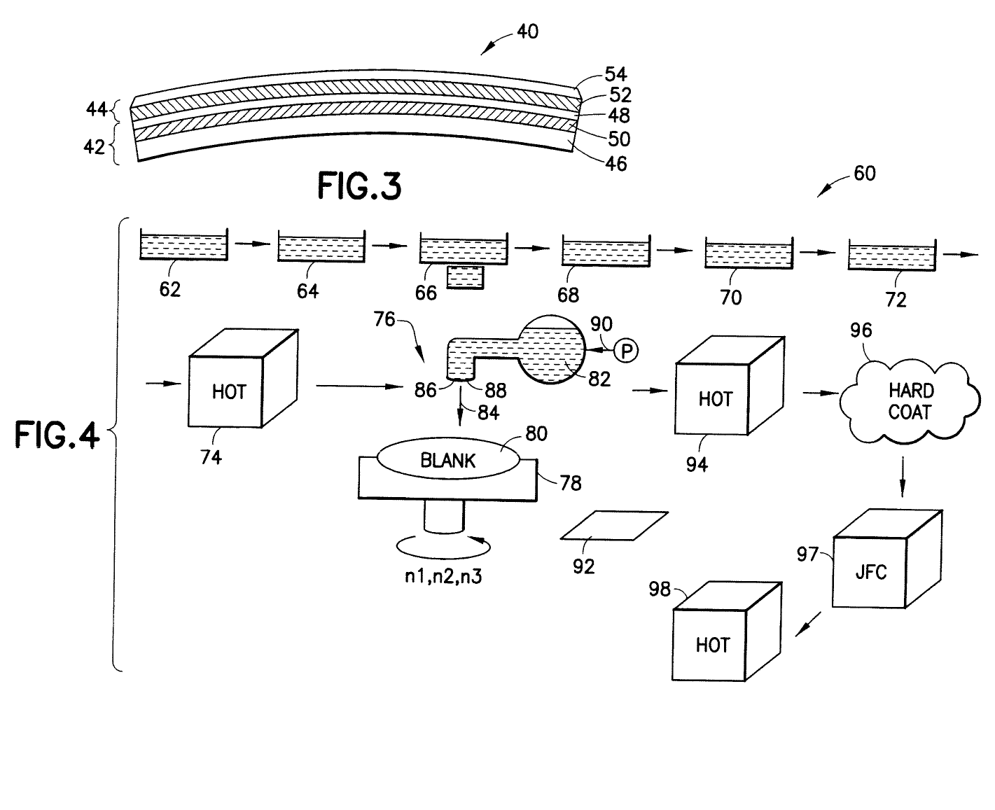

Referring now to FIG. 3, there is shown a schematic cross section of an anti-ballistic lens (or transparent or semi-transparent substrate) 40 in accordance with an exemplary embodiment. Anti-ballistic lens 40 may be used in helmet and visor shield 30, eyewear 10 (e.g. spectacles or goggles) or in any other suitable application. Anti-ballistic lens 40 generally has a substrate or power layer 42 and a functional layer 44. In the embodiment shown, power layer 42 may have lens substrate 46, 48 and an intermediate layer 50, for example, a polarizing layer. Alternately, layer 42 may comprise a single substrate with or without polarizing layer 50. The power layer may have a suitably shaped cross section (piano or non-plano) to provide any desired magnification and optical power characteristic to the power layer including zero magnification and zero optical power. The term power layer is used for exemplary purposes only. In the exemplary embodiment, anti-ballistic substrate or lens 40 may any suitable shape or application. For example, any suitable shape may be provided, such as spherical, aspheric, toric, bi-toric, or other suitable shape or for use on wrap around applications, eyewear, goggles, and may or may not be ophthalmic, or non-plano or piano lenses for any suitable use. In the case of anti-ballistic lenses, layer 42 may be made from a blank where the lens blank is anti-ballistic as previously described. For example, the lens blank material may be anti-ballistic armor and may meet testing requirements of either or both anti-ballistic Mil-Std-662 and impact resistant ANSI-Z87.1 and can be any suitable material exhibiting these properties. For example, the material may be polycarbonate, CR 39, Impacto™ Lenses manufactures by Carl Zeiss Vision capable of being formed to provide anti-ballistic armor properties to Mil-Std-662 or impact resistant ANSI-Z87.1 properties. Thickness of the blanks may be about 1-2 mm for eyewear (such as spectacles or goggles) applications. Alternately, any suitable thickness blank may be provided for eyewear applications or other suitable applications. The anti-ballistic blanks may be either cured or semicured. For example, in the event the anti-ballistic blanks are semicured, they are coated with the functional layer, for example a photochromic layer and finish cured to anti-ballistic armor properties of Mil-Std-662 or impact resistant ANSI-Z87.1 properties. In alternate embodiments, anti-ballistic lens substrate 46, 48 may be made from polycarbonate or polyurethane or any other suitable material. Polycarbonate polarized lenses are superior for outdoor sports applications because of their relative degree of shatter resistance compared to other optical lens materials. In other alternate embodiments, anti-ballistic may polyurethane polarized lenses may be used if desired because of their higher indices of refraction, resulting in polarized lenses that are thinner and lighter. Lens substrate 46, 48 may have differing levels of index of refraction. For example, a hard resin plastic lens may have an index of refraction of about 1.498. A mid-level of index may have an index of refraction of about 1.56. Lenses with high-level index of refractions, for example, may include polycarbonate with an index of about 1.58, 1.60 and 1.67. An Ultra-high-level index of refraction, for example, may have a range of about 1.7 to 1.8, or a tighter range of about 1.71-1.74. In alternate embodiments, other values or ranges may be provided; for example, a mid-level index of refraction of about 1.56 may have a range of about 1.5 to 1.6. A high-level index of refraction, for example, may have a range of about 1.6 to 1.7 or a tighter range of about 1.6-1.67. A Ultra-high-level index of refraction, for example, may have a range of about 1.7 to 1.8 or a tighter range of about 1.71-1.74. The names of the products by indices of refraction are terms of art in the industry and should be considered nominal names and not strict ranges. In the exemplary embodiment lens substrate 46, 48 may be made with polarizing layer 50. The polarized layer may be a polarizing filter that is created by stretching sheets of polyvinyl alcohol (PVA) so that its molecules align in long, directional chains. The PVA is then passed through an iodine solution where the light absorbing iodine molecules attach to the molecular PVA chains, thus forming microscopic blinds, which block polarized light. Two methods of fabrication of a polycarbonate polarized lens may be utilized: injecting polycarbonate plastic around an insert made with two thin pieces of a polycarbonate that are glued to a piece of polarized filter; and thermoforming a flat sheet consisting of two pieces of polycarbonate that are glued to a piece of polarized filter. In alternate embodiments, other fabrication techniques or materials may be used. A polycarbonate lens that can be used within this process without the polarized filter becoming damaged by excess heat is available from Intercast Europe S.P.S. in the form of the lens product with the tradename SINTER®PC Polar. In alternate embodiments, CR-19 hard resin available from Intercast Europe S.P.S. in the form of the lens product with the tradename SINTER®PC Polar can be used. In other alternate embodiments the lens blank may not include a polarized filter.

Layer 42 may have an uncoated lens or uncoated transparent blank or may alternately have a hard coat applied to the base blank. In the event the blank is uncoated or does not have a hard coat, a tie coat may be applied, for example, the tie coat may be aliphatic epoxy or aliphatic urethane or may be coat similar to a hard coat such as polysiloxane or may be any suitable coating. In the exemplary embodiment, the tie coat may be having a tie coat applied after cleaning uncoated blanks, for example, in de-ionized water cycles, with a dry cycle and possibly an isopropyl bath to remove water molecules from blank. Here, the process may be similar to the process described below. In the event the blank is hard coated, an etching step may be applied prior to application of the functional layer. In the exemplary embodiment, the hard coat may be etched to allow application and adhesion of the functional layer, for example a photochromic coat. The etch is applied so as not to remove the hard coat, leaving a functional hard coat to desired levels. In this manner, the remaining hard coat acts as barrier to the solvent carrier, during application of the functional layer photochromic coat, and blocking or minimizing contact between the solvents of the photochromic coat application and lens blank 42.

An example etching process may be by bath in mild alkalyne solution, for example, sodium hydroxide at about 140° F.±50° F. for between about 2-4 minutes or between about 2.5-3.5 minutes. In alternate embodiments, any suitable etching process may be used. After the etch, a cleaning process is similar to the process described herein may be applied. Functional layer 44 may be coated on the lens substrate 42. The functional layer may comprise a photochromic coating material 52, which is a resin-like solvent-born polymeric solution using the Exxene Corporation's Fotoshift II™ or Fotoshift™ and photochromic dyes as its principal component; and a glass-resin hard coat, which is coated onto the photochromic layer. In alternate embodiments, power layer 42 may comprise a single substrate with or without polarizing layer 50 upon which the functional layer may be applied. The functional layer may be coated onto the lens substrate 42 by any suitable means, such as spin coating onto the surface of the lens substrate 42 with a liquid resin of the photochromic material, and then curing the lens substrate by heating. In alternate embodiments, the functional layer may be applied by any suitable coating application, for example dip coat, spray coat, roll coat, flow coat or otherwise. As an example, flow coat may be used to apply functional layer 44 on substrates for visors or larger transparents. In alternate embodiments, the functional photochromic layer may also be applied by laminating a photochromic wafer onto the front surface of the lens substrate. In this case the base curve of the photochromic wafer may be the same as the base curve of the substrate with lamination accomplished by gluing or other desired bonding. An example of suitable photochromic dyes are available from ChromTech, Ltd. of Rhovot, Israel; and James Robinson, Ltd. Of Huddersfield, England. As noted before, functional layer 44 may be bonded, coated or otherwise coupled to the lens substrate 42. The functional layer may comprise a photochromic material 52 and a hard coating 54 coated on to the photochromic material 52. As noted before, in the exemplary embodiment, the functional layer may be coated on to the lens substrate 42 by any suitable means, such as spin coating a surface of the lens substrate 42 with a liquid resin of the photochromic material and then curing the lens substrate blank by heating. In alternate embodiments, the functional photochromic layer may be applied by a flow-coat or spray coat method, and then cured by heating or otherwise applied. As an example, the functional layer may be flow coated on a visor or other blank shape with a shape that is not conducive to spin coating.

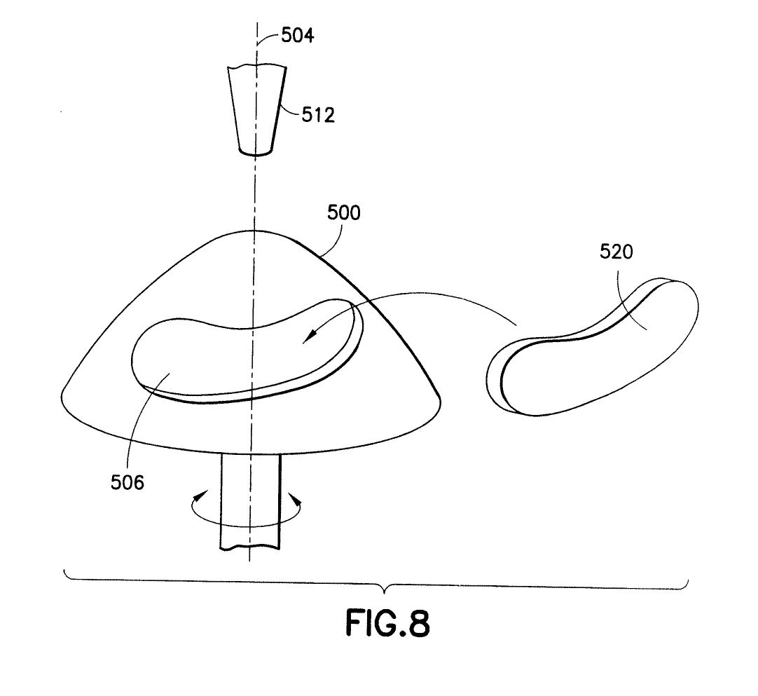

In accordance with another exemplary embodiment, and referring now to FIG. 8, a fixture 500 may be provided to normalize the shape of the blank 520 (otherwise similar to blank 42) to allow spin coat of blank 520 where otherwise spin coating the blank is not generally available. In the example shown, fixture 500 is used for spin coating and rotates about axis 504. Here an exemplary rounded surface is provided that allows liquid to be dispensed from nozzle 512 along axis 504. In the example shown, blank 520 is shown as a visor or goggle lens. In alternate embodiments, any suitable shape of fixture 500 or blank 520 may be provided. A recess or cutout 506 is provided in fixture 500 that allows blank 520 to be inserted and retained such that the surface of blank 520 substantially coincides and is substantially continuous with the surface of fixture 500 whereby the coating liquid may be uniformly spread across the fixture and the blank. The spin is controlled to have flow of the coating liquid over the contour of the combined surfaces. Here, when blank 520 is mounted into cutout 506, the surface of blank 520 completes the spheric/toric surface of fixture 500 allowing spin coating. In alternate embodiments, any suitable blank may be coated, for example a goggle shaped blank or other suitable blank.

Referring now to FIG. 4, there is shown a schematic view of an apparatus 60 for making a lens structure in accordance with an exemplary embodiment. In the exemplary embodiment, apparatus 60 may have a sodium hydroxide etch submersion apparatus 62 (for example as described previously), a de-ionized water rinsing apparatus 64, an ultrasonic soap bath apparatus 66, a de-ionized water rinsing apparatus 68, a first soaking separate de-ionized water bath 70, second soaking separate de-ionized water bath 72 with a higher level of purity than the first soak and drying oven 74 for preparing the lens blank. Alternatively, apparatus 60 may be an ultrasonic cleaning machine such as the Branson Degreaser Model B452-R, which uses as its primary cleaning solution DuPont Vertrel XP-10. For coating, apparatus 60 has a spin coating apparatus 76 for coating a photochromic material onto the lens blank. Apparatus 76 has a fixture 78 for and rotating or spinning the lens substrate blank at a first speed n1. Fixture 78 may be designed not to scratch the lens or affect yield. Photochromic coating is applied substantially at the center 80 of the lens, much like a flush coating of material. A resin liquid 82 of the photochromic material is dispensed on to the lens substrate blank in a liquid stream 84 by providing a dispenser, for example, a nozzle 86 located, for example, at about 1.5-5.0 inches above the surface of the lens substrate blank. In alternate embodiments, other distances could be provided. The nozzle may have, for example, an opening 88 about 0.04-0.07 inches in diameter. In alternate embodiments, any suitable diameter may be used, for example, 0.10 inch diameter. The resin liquid pressurized 90 at a pressure, for example, of about 1-5 pounds per square inch steady stream. In alternate embodiments, other pressures could be provided. The material may be dispensed in a stream that, in the exemplary embodiment, is approximately perpendicular to the lens and the flow is substantially straight down onto the lens. The lens may then be spun or rotated at a second speed n2 or at a third speed n3 for any desired duration. The lens may be removed via a tray or tool 92. A drying apparatus 94 may comprise a heating or curing station or oven. A hard coating apparatus 96 and oven curing apparatus 98 are also provided.

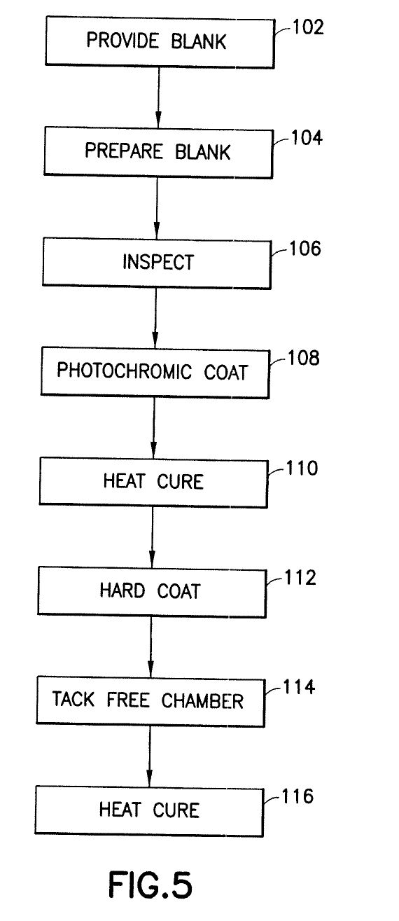

Referring now to FIG. 5, there is shown a flow diagram of a method of making a lens structure in accordance with an exemplary embodiment. Flow diagram 100 generally comprises, in block 102, starting with a lens blank (such as described before), in block 104, preparing the lens blank (such as also described before), in block 106, inspecting the lens blank, in block 108 of coating, in block 110, drying, in block 112 hard coating and in block 114 of curing (such as in an oven). The first step 102 of starting with a lens blank comprises providing a lens material with a polarizing layer of film. In this embodiment, the lens blank may be a cured or uncured blank having or being capable of anti-ballistic armor properties of Mil-Std-662 or impact resistant properties of ANSI-Z87.1 as previously described. In alternate embodiments, the lens blank may be a substrate of sandwiched polarizing film between two polycarbonate or polyurethane blanks. In alternate embodiments, other suitable materials may be provided in other combinations. The lens material may be pretinted, for example, by the polycarbonate or polyurethane lens manufacturer or otherwise, in the manufacturing process by adding color, such as by adding colorizing pellets to the raw material of the lens, or by applying a hard coat that is tinted a particular color by adding a solvent based permanent dye material to the hard coat. The preparation of the lens blank, block 104 may generally comprise cleaning and drying the blank. The lens may first be cleaned with, for example, a sodium hydroxide etch by submersion for approximately 10 minutes. The lens may then be rinsed in de-ionized water as noted before. The lens may then be placed in an ultrasonic soap bath for approximately 10 minutes. The lens may then again be rinsed in de-ionized water for approximately 3 minutes. The lens may then be first soaked in a separate bath of de-ionized water for approximately 5 minutes. The lens may then be soaked a second time in a separate bath of de-ionized water for approximately 5 minutes where the second soak may have a higher level of purity of the de-ionized water than the first soak. In alternate embodiments, the lens may be cleaned in any other desired manner with any other desired means. The lens may then be allowed to dry, for example, in an oven at approximately 100 degrees F. for approximately 15 minutes or in any other desired manner. In alternate embodiments, the lens may otherwise be cleaned, such as in an ultrasonic degreaser. In alternate embodiments, the lens may otherwise be cleaned, such as in an ultrasonic cleaning machine using cleaning solution, such as Vertrel cleaning solution. Referring to FIG. 3, layer 42 may have an uncoated lens or uncoated transparent blank or may alternately have a hard coat applied to the base blank. In alternate embodiments where the blank may be uncoated or does not have a hard coat, the preparation in block 104 may be modified so that a tie coat may be applied to the blank. For example as described before, the tie coat may be aliphatic epoxy or aliphatic urethane or may be coat similar to a hard coat such as polysiloxane or may be any suitable coating. Here, the tie coat may be applied after cleaning uncoated blanks, for example, in de-ionized water cycles, with a dry cycle and possibly an isopropyl bath to remove water molecules from blank. In the event the blank is hard coated, an etching step may be applied prior to application of the functional layer. Here, the hard coat is etched to allow application and adhesion of the functional layer, for example a photochromic coat. As described before, the etch is applied so as not to remove the hard coat, leaving a functional hard coat to desired levels. An example etching process is by bath in mild alkalyne solution, for example, sodium hydroxide at about 140° F.±50° F. for between 2-4 minutes or between 2.5-3.5 minutes. In alternate embodiments, any suitable etching process may be used. After the etch, a cleaning process is similar to the process described herein may be applied. The inspection of the lens blank in block 106 generally comprises an inspection for contaminants and flaws. The coating application in block 108 generally comprises coating, for example, spin coating a surface of the lens substrate blank with a photochromic material onto the lens. In this embodiment, spin coating a surface of the lens substrate blank with a photochromic material, holding the lens substrate blank in a fixture and rotating or spinning the lens substrate blank at a first speed. The fixture may be designed not to scratch the lens or affect yield. The photochromic material may be stored in a pressure pot, and transferred by low, pressurized nitrogen (1-10 psi) onto the top of the coating in the pressure pot, and through one absolute pleated media filter and an absolute blown depth filter to remove contaminants. Photochromic coating may be applied substantially at the center of the lens, much like a flush coating of material. A resin liquid of the photochromic material is dispensed on to the lens substrate blank in a liquid stream by providing a dispenser, for example, a nozzle located, for example, at about 1.5-5.0 inches above the surface of the lens substrate blank. In alternate embodiments, the nozzle may be located at any other desired location or distance from the surface. The nozzle may have, for example, an opening about 0.10 inches in diameter. In alternate embodiments, the nozzle may have, for example, an opening about 0.04-0.07 inches in diameter. The resin liquid of the photochromic material may be dispensed through the opening at a pressure, for example, of about 1-5 pounds per square inch steady stream. The material is applied in a stream; not a spray or circular spray. The material may be dispensed in a stream that, in the exemplary embodiment, may be approximately perpendicular to the lens and the flow is substantially straight down onto the lens. The coating material evenly disperses across the whole lens surface. In this embodiment, the coating may then be collected into a reclaim reservoir, then pumped through a filter to remove contaminants, and then supplied to the dispensing valve. The lens may then be spun or rotated at a second speed for about 10-20 seconds where the second speed may be greater than the first speed. The lens may then be spun or rotated at a third speed for about 10-20 seconds that may, in this embodiment, be greater than the second speed. For example, the first speed may be about 200-500 revolutions pre minute, the second speed may be about 300-700 revolutions per minute, and the third speed may be about 400-900 revolutions pre minute. In this embodiment, excess spin coated photochromic material is removed such that an additional step of removing excess spin coated photochromic material after stopping rotation of the lens substrate blank is not required. After the spin coating process, the lens may be removed via a tray or tool. Drying block 110, may comprise heating or curing the lens. The lens, for example, may be placed to cure in an oven to air dry at about 200-250 degrees F. for approximately 20-60 minutes. As previously described, there may be no need to remove excess photochromic material from the lens. Application of hard coating, block 112, comprises coating the lens with a scratch resistant material, and placing the wet coated lens in a clean chamber for 30 minutes so that the hard coat becomes tack free block 114. The hard coated transparent armor, in block 116, may be oven heated for example for about between 30-120 minutes at between about 200-250° F. Although the process has been described with respect to an uncoated or hard coated blank, in the event the blank is already coated, for example, with a functional layer, the layer may be stripped and the blank can have applied another coat with different coverage characteristics.

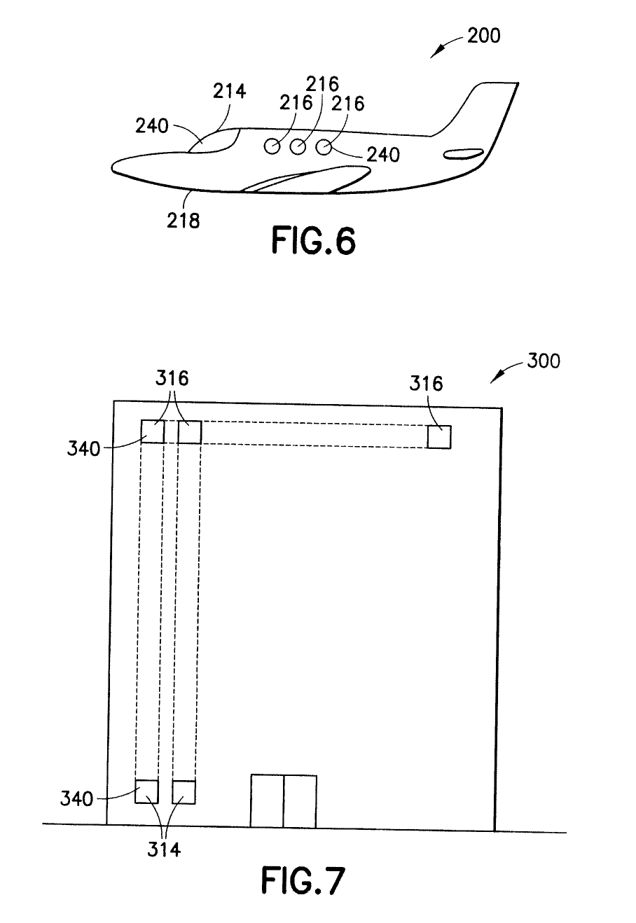

Referring now to FIG. 6, there is shown a schematic elevation view of a general vehicular conveyance/transport 200 capable of conveying/transporting one or more operators and occupants over a distance and incorporating features of the exemplary embodiment in accordance with another exemplary embodiment. In the embodiment in FIG. 6, the vehicle 200 is illustrated for example purposes only as an aircraft. In alternate embodiments, the vehicle may be any suitable kind of vehicular conveyance/transport such as an automobile, bus, high mobility transport (wheeled or tracked), boat, etc. Vehicle 200 has a suitable frame 218 capable of holding the operators and occupants. The frame 218 also defines a number of view openings/ports through which the operators and occupants can view desired regions outside the vehicle. The view openings/ports may be closed by anti-ballistic or high impact resistant transparent material 240, as will be described further below, protecting the operators and occupants from ballistic projectiles and other environmental conditions exterior to the vehicle, and isolating, if desired, the space inside the frame 218 interior from ambient conditions exterior to the vehicle. Thus, in this embodiment, vehicle 200 has an armored windscreen or windshield 214, through which the operators and occupants may view the area in front of the vehicle, and armored side or rear windows 216 for viewing other areas outside the vehicle. In this embodiment, material 240 is used for both the windshield 214 and the side windows 216. In alternate embodiments, material 240 may be used for more or fewer openings. Window material 240 may be substantially similar to lens material 40 described in detail before and shown in FIG. 3. For the detailed description of the makeup and fabrication of window material 240, reference is made back to FIGS. 3-5 and related description. Window material 240 generally includes a layer similar to power layer 42, though in this case possibly with zero optical magnification and zero optical power. The power layer of material 240 may have polycarbonate or polyurethane lens substrates similar to substrates 46, 48 and a polarizing layer similar to layer 50 in FIG. 3. Window material 240 may also have a functional layer, similar to layer 44 in FIG. 3, that comprises the photochromic coating material similar to layer 52 described before and shown in FIG. 3. During formation of the window material 240, the material may be molded to any desired shape, such as a suitable aerodynamic shape, for windshield 214 and windows 216 installation onto frame 218.

Referring now to FIG. 7, there is shown a schematic elevation view of an exemplary building 300 incorporating features of the exemplary embodiment in accordance with yet another exemplary embodiment. Building 300 is depicted generally as a multistory building, having a generally hexahedron shape, but may be any suitable shaped and sized building. Building 300 may be configured for residential (either single or multi-unit occupancy), or office, or combined residential and office use as desired. As seen in FIG. 7, the building 300 has a number of anti-ballistic or high impact resistant windows 314-316 (the window shape and arrangement shown in FIG. 7 is merely exemplary). The windows 314-316 are covered with a transparent window material 340 that is anti-ballistic or transparent armor to MIL-STD-662, or may be high impact resistant to ANSI-Z87.1. Window material 340 is substantially similar to lens material 40 described before and shown in FIG. 3. Window material 340 may include a layer similar to power layer 42 in FIG. 3, but if desired with zero optical power and zero magnification. This layer of material 340 may have substrates similar to layers 46, 48, of polycarbonate or polyurethane material, and a polarizing layer, similar to layer 50. In alternate embodiments, window material 340 may not have a polarizing layer. Window material 340 may also have a functional layer similar to layer 44 with a photochromic layer similar to layer 52, in FIG. 3.

In alternate embodiments, anti-ballistic material substantially similar to anti-ballistic lens material 40 described in detail before and shown in FIG. 3 may be applied to product applications over and entire range of optical or transparent substrates. For example, anti-ballistic spectacles, goggles, visors, face shields, windows, windscreens of vehicles, lenses of optical devices, or transparent armor or other suitable applications.

It should be understood that the foregoing description is only illustrative of the invention. Various alternatives and modifications can be devised by those skilled in the art without departing from the invention. Accordingly, the exemplary embodiment is intended to embrace all such alternatives, modifications and variances that fall within the scope of the appended claims.

What is claimed is:

1. A method of making an anti-ballistic lens structure comprising:
providing a lens substrate blank of anti-ballistic material; and
applying a photochromic material to a surface of the lens substrate blank.

2. The method of claim 1, wherein providing a lens substrate blank comprises providing MIL-STD-662F anti-ballistic material.

3. A method of making an anti-ballistic lens structure comprising:
providing a lens substrate blank of anti-ballistic material;
applying a photochromic material to a surface of the lens substrate blank; and
curing the lens substrate blank.

4. The method of claim 3 wherein applying a photochromic material to a surface of the lens substrate blank comprises spin coating the photochromic material on to the lens substrate blank.

5. The method of claim 3 wherein curing the lens substrate blank comprises heating the lens substrate blank.

6. The method of claim 3 further comprising coating the surface of the lens substrate blank having the photochromic material with a hard coating.

7. The method of claim 3 wherein the lens substrate blank is semi cured.

8. The method of claim 3 wherein providing a lens substrate blank of anti-ballistic material comprises providing an uncoated blank.

9. The method of claim 3 wherein providing a lens substrate blank of anti-ballistic material comprises providing a hard coated blank.

10. The method of claim 4 wherein spin coating comprises rotating the lens substrate blank; and wherein there is no removal of excess spin coated photochromic material after stopping rotation of the lens substrate blank.

11. The method of claim 3 wherein providing a lens substrate blank comprises at least one of:
etching the lens substrate blank;
rinsing the lens substrate blank;
bathing the lens substrate blank in an ultrasonic bath;
rinsing the lens substrate blank;
soaking the lens substrate blank in de-ionized water; and
drying the lens substrate blank by heating the lens substrate blank.

12. The method of claim 3 wherein providing a lens substrate blank of anti-ballistic material further comprises ultrasonic cleaning the lens substrate blank in Vertrel cleaning solution in an ultrasonic cleaning machine.

13. The method of claim 11 wherein soaking the lens substrate blank in de-ionized water comprises a first soaking of the lens substrate blank in de-ionized water and a second soaking of the lens substrate blank in de-ionized water of a higher purity than de-ionized water used in the first soaking.

14. The method of claim 4 wherein spin coating a surface of the lens substrate blank with a photochromic material comprises:
holding the lens substrate blank in a fixture;
spinning the lens at a first speed;
dispensing a resin liquid of the photochromic material to the lens substrate blank in a liquid stream; and
spinning the lens at a second speed different from the first speed.

15. The method of claim 14 wherein dispensing a resin liquid of the photochromic material to the lens substrate blank in a liquid stream comprises:
providing a nozzle about 1.5 to 5.0 inches above the surface of the lens substrate blank, the nozzle having an opening of 0.10 inches in diameter nominal; and
dispensing the resin liquid of the photochromic material through the opening at a pressure of about 1 to 5 pounds per square inch.

16. The method of claim 14 wherein the second speed is greater than the first speed; and wherein spinning the lens at a second speed further comprises spinning the lens at a third speed greater than the second speed.

17. The method of claim 16 wherein the first speed is about 200 to 500 revolutions per minute; the second speed is about 300 to 700 revolutions per minute; and the third speed is about 400 to 900 revolutions per minute.

18. An anti-ballistic eyewear lens structure comprising:
a lens substrate of anti-ballistic material; and
a functional layer coated on the lens substrate, the functional layer comprising a photochromic material;
wherein no hard coat is required.

19. An anti-ballistic eyewear lens structure comprising:
a lens substrate of anti-ballistic material having a polarizing layer; and
a functional layer coated on the lens substrate, the functional layer comprising a photochromic material;
the functional layer being coated on to the lens substrate by spin coating a surface of the lens substrate with a liquid resin of the photochromic material and curing the lens substrate blank by heating.

20. An anti-ballistic eyewear lens structure comprising:
a lens substrate of anti-ballistic material; and
a functional layer coated on the lens substrate, the functional layer comprising a photochromic material;
the functional layer being coated on to the lens substrate by spin coating a surface of the lens substrate with a liquid resin of the photochromic material and curing the lens substrate blank by heating.

21. The anti-ballistic eyewear lens structure of claim 20 further comprising a hard coating coated on to the functional layer.

22. The anti-ballistic eyewear lens structure of claim 20 wherein excess spin coated photochromic material is not removed.

23. The anti-ballistic eyewear lens structure of claim 20 wherein the lens substrate is prepared for coating by at least one of etching the lens substrate; rinsing the lens substrate; bathing the lens substrate in an ultrasonic bath; rinsing the lens substrate; soaking the lens substrate in de-ionized water; and drying the lens substrate by heating the lens substrate.

24. The anti-ballistic eyewear lens structure of claim 20 wherein the functional layer coated on to the lens substrate has a structure formed by spinning the lens at a first speed while dispensing the resin liquid of the photochromic material on the lens substrate in a liquid stream; subsequently spinning the lens at a second speed greater than the first speed; and subsequently spinning the lens at a third speed greater than the second speed.

25. The anti-ballistic eyewear lens structure of claim 20 with the functional layer being coated on to the lens substrate by spin coating a surface of the lens substrate with a liquid resin of the photochromic material by providing a nozzle about 1.5 to 5.0 inches above the surface of the lens substrate blank, the nozzle having an opening about 0.1 inches in diameter; and dispensing the resin liquid of the photochromic material through the opening at a pressure of about 1 to 5 pounds per square inch.

26. An anti-ballistic eyewear lens structure comprising:
an anti-ballistic lens substrate having another layer; and
a functional layer applied to the other layer of the lens substrate, the functional layer comprising a photochromic material.

27. The anti-ballistic eyewear lens structure of claim 26 wherein the other layer of the anti-ballistic lens substrate comprises a hard coat layer.

28. The anti-ballistic eyewear lens structure of claim 26 wherein the other layer of the anti-ballistic lens substrate comprises an aliphatic tie coat.

29. The anti-ballistic eyewear lens structure of claim 26 wherein the functional layer is applied by spin coating.

30. The anti-ballistic eyewear lens structure of claim 26 wherein the other layer is a polarizing layer.

31. Anti-ballistic eyewear comprising:
a frame and at least one anti-ballistic lens, the anti-ballistic lens being shaped to a non-prescription specification and having a lens structure comprising:
an anti-ballistic lens substrate having another layer; and
a functional layer applied to the other layer of the lens substrate, the functional layer comprising a photochromic material;
wherein the other layer of the lens substrate comprises a hard coat material.

32. Anti-ballistic eyewear comprising:
a prescription insert frame having clear prescription lenses, the clear prescription lenses having an index of refraction of 1.50, 1.56, 1.60, 1.67, 1.71, or 1.74;
a frame and at least one non-prescription anti-ballistic lens in front of the prescription lenses, the non-prescription anti-ballistic lens having a lens structure comprising:
a anti-ballistic lens substrate having another layer; and
a functional layer applied to the other layer of the lens substrate, the functional layer comprising a photochromic material;
wherein the other layer of the lens substrate comprises a hard coat.

33. An anti-ballistic protective helmet having head protection gear and a visor or shield comprising:
a anti-ballistic lens substrate having another layer; and
a functional layer applied to the other layer of the lens substrate, the functional layer comprising a photochromic material;
wherein the other layer of the lens substrate comprises a hard coat.

34. Anti-ballistic eyewear comprising:
a frame and at least one anti-ballistic lens, the anti-ballistic lens being shaped to a prescription or non-prescription specification and having an anti-ballistic lens structure comprising:
a anti-ballistic lens substrate having another layer; and
a functional layer applied to the other layer of the anti-ballistic lens substrate, the functional layer comprising a photochromic material.

35. The anti-ballistic eyewear of claim 34, wherein the other layer is a hard coat layer.

36. The anti-ballistic eyewear of claim 34, wherein other layer is a tie coat layer.

37. The anti-ballistic eyewear of claim 34, further comprising a polarizing layer, and wherein and the anti-ballistic lens has a tint selected from one of the colors amber, brown, aquamarine, blue, gray and purple.

38. The anti-ballistic eyewear of claim 34 further comprising a hard coat layer applied over the functional layer.

39. The anti-ballistic eyewear of claim 34, further comprising a polarizing layer, and wherein the anti-ballistic lens has a tint color of yellow.

40. An anti-ballistic protective helmet having head protection gear and a visor or shield comprising:
a anti-ballistic transparent or translucent substrate; and
a functional layer applied to the anti-ballistic transparent or translucent substrate, the functional layer comprising a photochromic material.

41. An anti-ballistic aircraft cockpit window comprising:
a anti-ballistic transparent substrate; and
a functional layer applied to the anti-ballistic lens substrate, the functional layer comprising a photochromic material.

42. An anti-ballistic residential or office building window comprising:
an anti-ballistic transparent substrate; and
a functional layer applied to the anti-ballistic transparent substrate, the functional layer comprising a photochromic material. polycarbonate or polyurethane.

43. An anti-ballistic vehicular window comprising:
an anti-ballistic transparent substrate; and
a functional layer applied to the other layer of the anti-ballistic transparent substrate, the functional layer comprising a photochromic material.
